(19) United States
(12) Patent Application Publication
(10) Pub. No.: US 2006/0077165 A1
(43) Pub. Date: Apr. 13, 2006

(54) Wireless LCD device for displaying images received from a mobile communication terminal and an operation method thereof

(75) Inventor: Chang-Weon Jang, Woobang Dream City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/215,130

(22) Filed: Aug. 31, 2005

(30) Foreign Application Priority Data
Oct. 12, 2004 (KR) 2004-81217
Jun. 15, 2005 (KR) 2005-51509

(51) Int. Cl. G09G 3/36

(52) U.S. Cl. 345/97

(57) ABSTRACT

Disclosed is a wireless liquid crystal display (LCD) apparatus including a mobile communication terminal for establishing a link through which at least one wireless display device is linked to the mobile communication terminal, and transmitting image frames having image data to the linked wireless display device, wherein when receiving control frames for controlling the image frames from the wireless display device, the mobile communication terminal generates image frames based on the received control frames; and the wireless display device for receiving the image frames from the mobile communication terminal and displaying image data of the received image frames, if the wireless LCD apparatus is linked to the mobile communication terminal in response to a link setup request of the mobile communication terminal, wherein when receiving a user's control command for controlling the image data, the wireless display device generates the control frames based on the received control command and transmits the generated control frames to the mobile communication terminal. The bidirectional communication can be performed between the mobile communication terminal and the wireless display device, whereby a variety of applications for controlling dynamic images can be realized.

### PRIORITY

This application claims the benefit under 35 U.S.C. 119(a) of an application entitled “WIRELESS LCD DEVICE FOR DISPLAYING IMAGES RECEIVED FROM A MOBILE COMMUNICATION TERMINAL AND OPERATION METHOD THEREOF” filed in the Korean Industrial Property Office on Oct. 12, 2004 and assigned Serial No. 2004-81217, and an application filed in the Korean Industrial Property Office on Jun. 15, 2005 and assigned Serial No. 2005-51509, the entire contents of which are hereby incorporated by reference.

### BACKGROUND OF THE INVENTION

1. Field of the Invention

The present invention relates to a display device. More particularly, the present invention relates to a wireless display device for displaying image information of a mobile communication terminal and a data exchanging method thereof.

2. Description of the Related Art

Based on advancements in technology, the portable terminal provides not only a wireless communication function, but also provides additional functions such as camera means, multimedia reproducing means and so on. Such multimedia functions in mobile communication terminals have been increasingly applied to a wider range of practical uses owing to both the significant progress of display devices of portable terminals and the realization of advanced high-speed communication. As a result, mobile communication terminals having multi-functions have been commercially available and have gradually transformed into portable entertainment systems. Specifically, the camera function and the multimedia reproducing function are regarded as higher-grade functions among all the multimedia functions. And such higher-grade functions in the portable terminals have provided capabilities for photographing through the camera function and for watching and listening to Video On Demand (VOD) with a superior image quality.

The display device for displaying the image data or other additional function services, however, has a limited size corresponding to that of the LCD device part in the mobile communication terminal for providing convenience and easy-mobility. Therefore, in homes where the users are less mobile or have limited range, the additional functions are rarely used. That is, there is a problem that in homes, the portable terminal tends to be used solely for its telephone function in spite of the multi-functions available.

FIG. 1 is a schematic diagram illustrating a structure of a display device for displaying image outputs in accordance with a conventional mobile communication terminal. The display device includes a processor 100 for executing a communication operation and an image processing operation for the image output, a frame buffer 102 for buffering therein the image data output from the processor 100, a LCD driver 104 for driving the LCD device to display the image data output from the frame buffer 102 thereon, and a LCD display 106 serving as the display device (hereinafter referred to as “the LCD device”) for displaying digital image data thereon with the driving of the LCD driver 104.

Although such a conventional mobile communication terminal can output the image data through the LCD device mounted therein, the LCD device has been limited in size due to restrictions such as portability and mobility, manufacturing cost, electrical power consumption and so on of the portable terminal.

And, in recent years, according to further advancements in technology for mobile communications, very high resolution color images can be realized through the display device such as the LCD to provide, for example, a wide variety of games requiring high resolution color images. However, since conventional portable terminals have LCD devices limited size, there is a problem that the user may not be satisfied with the display images.

Furthermore, it is difficult to enlarge the size of the display because both the processor 100 and the LCD device space (LCD display 106) are designed based on wireless communication. Consequently, the limited display size of the mobile communication terminal limits the use of internet connections for web surfing, e-mail, etc.

To solve the problems of the prior art mentioned above, Korean patent application No. 10-2000-40086, which is incorporated herein by reference, discloses a “wireless LCD device” characterized in that a main unit (a processor) is separated physically from the LCD device, and the main unit and the LCD device can communicate with each other by local wireless communication (RF communication) to display predetermined images on the wireless LCD device. The conventional wireless LCD device of the prior art, however, has some the following problems:.

First, in the conventional wireless LCD device, the main unit transmits unilaterally the predetermined images in the form of RF serial data to the wireless LCD device using a serial data communication system, and not bidirectionally between the main unit and the LCD device. That is, the conventional wireless LCD device has a directional structure for unilaterally receiving the data in one direction so that the wireless LCD device can not send the main unit, for example, control data for selecting certain images which can be transmitted only by a bi-directional communication system. Second, the conventional wireless LCD can perform only point-to-point (or 1:1) serial communication between a mobile communication terminal and a single wireless LCD device but cannot realize point-to-multipoint (or 1:N) communication between a mobile communication terminal and a plurality of wireless LCD devices.

Third, the conventional wireless LCD device does not have a key input section such as a key pad or a touch panel accompanied therein. Therefore, the user can not make direct image control through operation of the key input section or the keypad, which is very inconvenient to the user.

### SUMMARY OF THE INVENTION

Accordingly, the present invention has been made to solve the above-mentioned problems occurring in the prior art, and an object of the present invention is to provide a wireless liquid crystal display (LCD) device which is capable of performing bi-directional communication with the portable mobile communication terminal and a method for exchanging data in the device.

Another object of the present invention is to provide a wireless LCD device in which one-to-N (Point-to-Multipoint) multi-communications between the mobile communication terminal and at least one of the LCD devices can be effected and a method for exchanging data in the device thereof.

In order to accomplish this object, according to one aspect of the present invention, a wireless liquid crystal display (LCD) apparatus is provided comprising a mobile communication terminal for establishing a link through which at least one wireless display device is linked to the mobile communication terminal, and transmitting image frames having image data to the linked wireless display device, wherein when receiving control frames for controlling the image frames from the wireless display device, the mobile communication terminal generates image frames based on the received control frames, if the wireless display device is linked to the mobile communication terminal in response to a link setup request of the mobile communication terminal when receiving a user's control command for controlling the image data, the wireless display device generates the control frames based on the received control command and transmits the generated control frames to the mobile communication terminal.

According to another aspect of the present invention, a method is provided for exchanging data in a mobile communication terminal between at least one wireless display device and a mobile communication terminal. The method comprises the steps of registering each specific ID of said at least one wireless LCD device to the mobile communication terminal, radiating a link request frame comprising the specific ID over the wireless communication if there is a user's link setup request, transmitting image frames comprising image data to the wireless display device if a link request approval frame has been transmitted from a predetermined wireless display device having its own specific ID and a link has been established based on the link request approval frame, and generating an image frame based on a control frame and transmitting the generated image frame to the wireless display device if the control frame for controlling the image frame has been transmitted from the wireless display device.

According to still another aspect of the present invention, a method is provided for exchanging data in the wireless LCD apparatus which receives images from a predetermined mobile communication terminal and displays the received images thereon. The method comprises the steps of transmitting a frame for accepting a link request approval frame to the mobile communication terminal and establishing a link based on the link request approval frame if a link request frame is received from the mobile communication terminal, displaying image data included in a predetermined image frame if the predetermined image frame is received from the mobile communication terminal for which the link has been established, generating a control frame based on an image control command to transmit the generated control frame to the mobile communication terminal if the image control command for controlling the image data is received, and receiving, from the mobile communication terminal, the image frame which has been generated based on the control frame, and displaying an image data corresponding to the received image frame.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic diagram illustrating a wire connecting status between a main unit and a display device according to a prior art;

FIG. 2 is a schematic diagram illustrating a data exchanging state based on a bi-directional communication between a mobile communication terminal and a wireless liquid crystal display (LCD) device according to an embodiment of the present invention;

FIG. 3 is a schematic diagram illustrating an interior structure of the wireless LCD device according an embodiment of the present invention;

FIG. 4 is a schematic diagram illustrating an interior structure of a radio frequency (RF) module in the mobile communication terminal according to an embodiment of the present invention;

FIG. 5A is a view illustrating an interior structure of a control frame according to an embodiment of the present invention;

FIG. 5B is a view illustrating an interior structure of an image frame according to an embodiment of the present invention; and

FIG. 6 is a flowchart illustrating a link setting process and a data exchanging process for bi-directional communication according to an embodiment of the present invention.

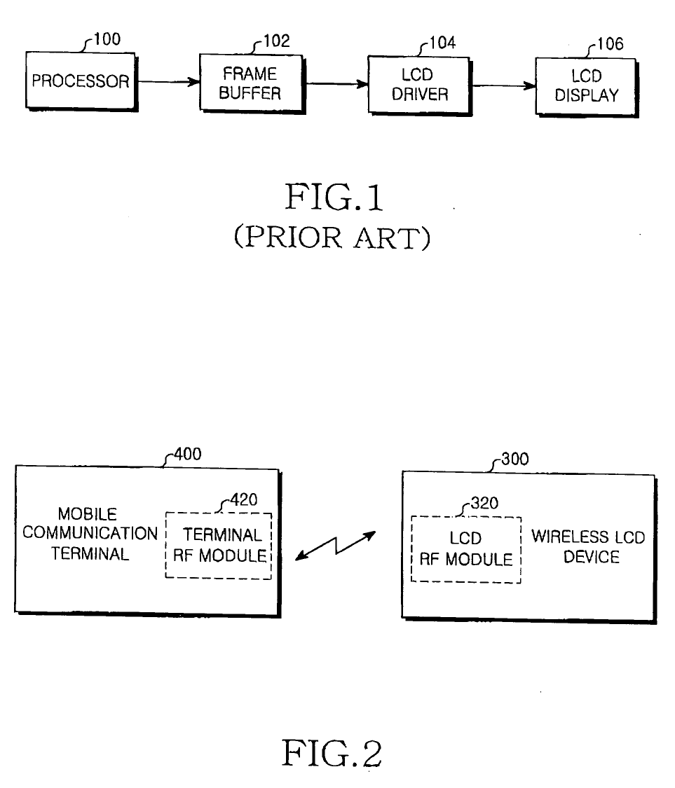

Throughout the drawings, the same or similar elements are denoted by the same reference numerals.

### DETAILED DESCRIPTION OF EXEMPLARY EMBODIMENTS

Hereinafter, embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are exemplary, and it is apparent to those skilled in the art that the present invention can be implemented without such examples. Further, in the following description of the present invention, a detailed description of known functions and configurations incorporated herein will be omitted when it may make the subject matter of the present invention rather unclear.

FIG. 2 illustrates a data exchanging state based on a bidirectional communication between a mobile communication terminal 400 and a wireless LCD device 300 according to an embodiment of the present invention. In the embodiment of the present invention, it is assumed that the wireless display device corresponds to the Liquid Crystal Display (LCD) Each one of the mobile communication terminal 400 and the wireless LCD device 300 has a RF module for exchanging data with each other, respectively. Hereinafter, the RF module for the mobile communication terminal 400 is referred to as “a terminal RF module 420”, and the RF module for the wireless LCD device 300, is referred to as “a LCD RF module 320”.

The mobile communication terminal 400 transmits image frames comprising image data through the terminal RF module 420 to the LCD RF module 320 of the wireless LCD device 300 and receives predetermined control frames comprising control data such as image selecting data and image extending data and the like from the LCD RF module 320.

Similarly, the wireless LCD device 300 receives the image data from the terminal RF module 420 of the portable terminal 400, and transmits the predetermined control frames to the terminal RF module 420 through the LCD RF module 320.

The image frame has a header area for storing basic information for the wireless communication and a data area for storing the image data to be transmitted. The control frame has a header area for storing basic information for the wireless communication and a control data area for storing control data which are generated based on the users' requests.

The mobile communication terminal 400 sets up a link to at least one wireless LCD device 300 to transmit the image frame comprising the image data to the linked LCD device 300. Also, when receiving the control frames for the image frame from the wireless LCD device 300, the mobile communication terminal 400 generates and transmits the image frames based on the received control frames.

The wireless communication or RF communication between the terminal RF module 420 and the LCD RF module 320 requires more than 500 Mbps of a data transmission speed for insuring a sufficient image transmission speed and an effective efficiency thereof, which can be realized by a variety of technologies (for example, W-LAL method).

Meanwhile, the mobile communication terminal 400 and the wireless LCD device 300 have a specific identity (ID) respectively through which they can be identified with each other and the wireless links between them can be set. Accordingly, one mobile communication terminal 400 can select one or a plurality of the wireless LCD devices 300 as external or separate display means.

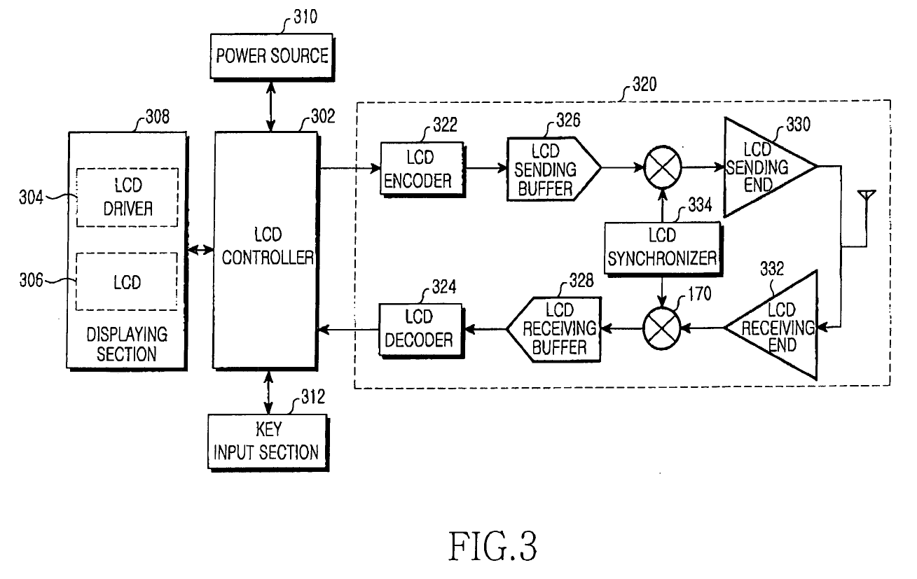

FIG. 3 illustrates an interior structure of the wireless LCD device according to an embodiment of the present invention.

The wireless LCD device 300 of FIG. 3 has a displaying section 308, a LCD controller 302, a power source 310, a key input section 312 and a LCD RF module 320.

The displaying section 308 comprises a LCD driver 304 and a LCD 306. The LCD driver 304 is a driving means for controlling the LCD 306 to display the images thereon. And the LCD driver 304 has setting values and control data therein for driving the LCD.

A power source 310 supplies electrical power to the wireless LCD device and has a voltage module and a charge module for stably charging the electrical power.

A key input section 312 which is an interface means for receiving commands from a user, has an input means such as a keypad and a touch panel and so forth. Accordingly, via the key input section 312, the user can input predetermined commands for selecting and controlling necessary images from among a plurality of images presented on the wireless LCD device.

The LCD controller 302 controls the operation of the wireless LCD device 300 according to an embodiment of the present invention. Also, when receiving the image control command from the user through the key input section 312, the LCD controller 302 generates the control frames based on the image control command and directs the LCD RF modules to transmit the generated control frames to the mobile communication terminal 400.

For example, if the user inputs a control command for repeating, stopping or enlarging certain images from among all the images displayed on the display section 308 through the key input section 312, a LCD controller 302 generates a control frame based on the control command input from the key input section 312 to transmit the control frame to the mobile communication terminal 400 via the LCD RF module 320. And then, the portable terminal extracts the control command from the received control frame and performs a corresponding control operation based on the extracted control command to generate the image frames and transmit the frames to the wireless LCD device 300.

The LCD RF module 320 comprises a LCD encoder 322, a LCD decoder 324, a LCD sending buffer 326, a LCD receiving buffer 328, a LCD sending end 330, a LCD receiving end 332 and a LCD synchronizer 334. Accordingly, with these elements, the LCD RF module 320 can perform bidirectional communication with the portable mobile communication terminal 400, receive the image frames comprising the image data from the portable mobile communication terminal 400, and transmit the control frames comprising the image control data to the portable mobile communication terminal 400.

The LCD encoder 322 generates a control frame for increasing transmission efficiency. More specifically, the LCD encoder 322 assigns a header such as a specific ID to each control data to be transmitted such that the control frames can be generated.

The LCD sending buffer 326 stores temporarily the control frames output from the LCD encoder to, then, transmit them by wireless communication.

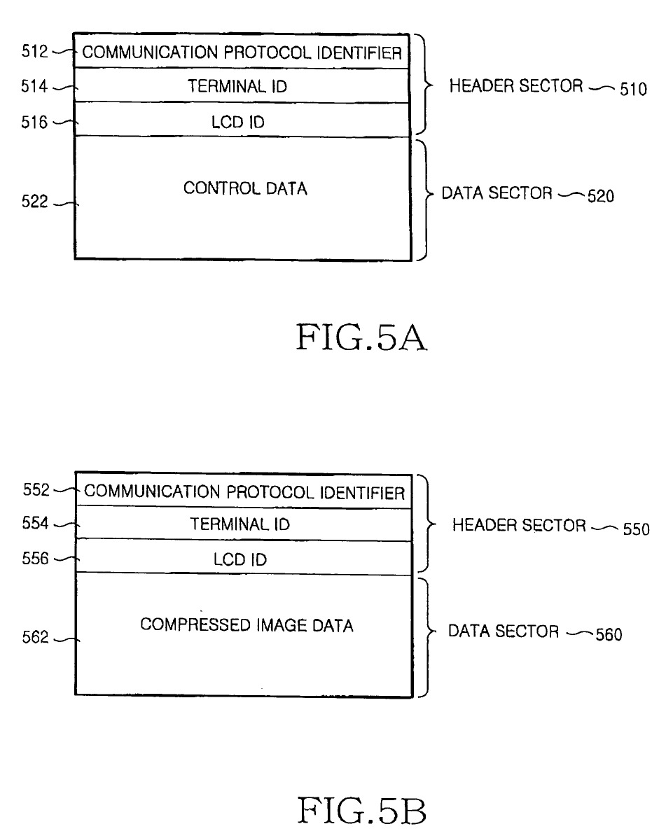

FIG. 5A illustrates an example of the control frame mentioned above, and an interior structure of the control frame according to an embodiment of the present invention.

Referring to FIG. 5, the control frame comprises a header sector 510 and a control data sector 520. And the header sector 510 comprises a communication protocol identifier 512 for representing types of frames and communication protocols between the mobile communication terminal 400 and the wireless LCD device 300, the specific identity of the mobile communication terminal (hereinafter, referred to as “a terminal ID 514”), and the specific identities of the wireless LCD device (hereinafter referred to as “a LCD ID 516”) for receiving the transmitted frames. The control data sector 520 comprises a control data 522 for storing control commands input by a user.

The terminal ID 514 comprises, for example, an electronic serial number (ESN) which is an identification number assigned specifically to the mobile communication terminal when manufactured. And like the ESNESN of the terminal ID, the LCD ID 516 also comprises a specific ID which is assigned to the LCD device 300 when manufactured.

The LCD synchronizer 334 provides synchronization (Sync) between the wireless LCD device and external entities via RF communication. More specifically, the LCD synchronizer provides synchronization through a mixer 170 such that it generates reference clocks based on a system clock for transmitting and receiving signals over a wireless communication.

The LCD sending end radiates synchronized control frames into the air or to external to the wireless LCD device whereas the LCD receiving end 332 receives the image frames transmitted from the mobile communication terminal located external to the display for storing the received image frames in the LCD receiving buffer 328. In other words, the LCD sending end 330 and the LCD receiving end 332 enable data communication with the terminal RF module 420 by transmitting and receiving the frames over a predetermined communication channel (for example, 2.5 GHz).

The LCD decoder 324 decodes the image frames received sequentially from the LCD receiving buffer to extract image data from them and send the extracted image data with header information related thereto to the LCD controller 302.

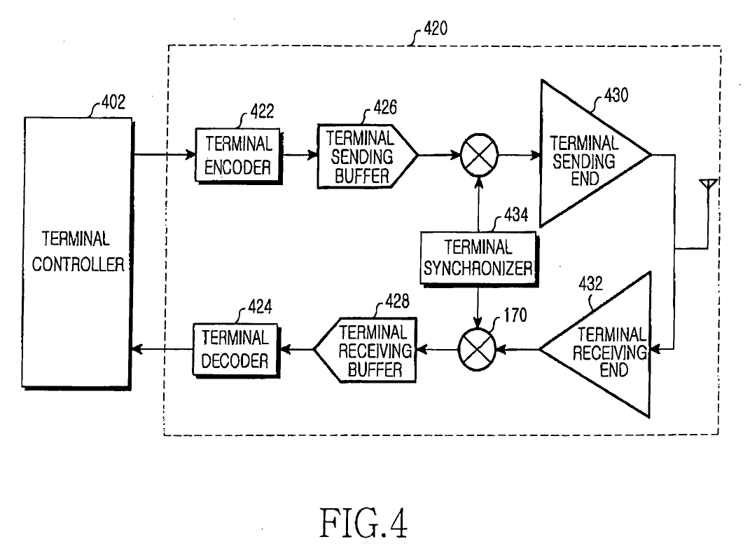

FIG. 4 is a schematic diagram illustrating an interior structure of the mobile communication terminal according to an embodiment of the present invention.

FIG. 4 shows the RF modules comprising essential elements for practicing the present invention, which are selected for brief description, among general interior elements of the mobile communication terminal.

The portable mobile communication terminal 400 of FIG. 4 comprises a terminal controller 402 and a terminal RF module 420. Also, the mobile communication terminal 400 may also comprise an input section (not shown) for allowing the user to request a link setup to a predetermined wireless LCD device.

The terminal controller 402 controls the operation of the mobile communication terminal 400.

The terminal controller 402 registers specific IDs of at least one wireless LCD device 300 therein. When receiving the user's link setup request, the terminal controller 402 controls the related elements to transmit the link setup request frame comprising the specific ID over the wireless RF communication.

When a frame for accepting the link setup request such as a link setup request approval frame has been transmitted to complete the setup of the desired link, the terminal controller 402 transmits the image frames comprising the image data to the wireless LCD device 300.

Also, when receiving control frames for controlling the image frames from the wireless LCD device 300, the terminal controller 402 generates image frames based on the received control frames in order to transmit the generated image frames to the wireless LCD device 300.

The block sections of the terminal RF module 420 are similar to those of the LCD RF module 320 shown in FIG. 3 in the functions performed thereof. Like the LCD RF module 320, the terminal RF module 420 comprises a terminal encoder 422, a terminal decoder 424, a terminal sending buffer 426, a terminal receiving buffer 428, a terminal sending end 430, a terminal receiving end 432, and a terminal synchronizer 434.

Reference numeral 170 in both FIGS. 3 and 4 indicates a mixer, and a reference numeral 402 in FIG. 4, a terminal controller.

As mentioned above, functions of the block sections in the terminal RF module corresponds to those of the block sections in the LCD RF module which comprises the LCD encoder 322, the LCD decoder 324, the LCD sending buffer 326, the LCD receiving buffer 328, the LCD sending end 330, the LCD receiving end 332, and the LCD synchronizer 334. The terminal encoder 422 generates the image frames by encoding the image data to be transmitted to the LCD RF module.

An example of the image frame is shown in FIG. 5B. FIG. 5B is a view illustrating the interior structure of the image frame according to an embodiment of the present invention.

Referring to FIG. 5B, the image frame comprises mainly a header sector 550 and a data sector 560. The header sector 500 comprises fields for a communication protocol identifier 552, a terminal ID 554, and a LCD ID 556, whereas the data sector 560 comprises a compressed image data 562. The compressed image data 562 can be produced by compressing the image data to be transmitted in the manner of, for example, MPEG or a variety of compressing algorithms.

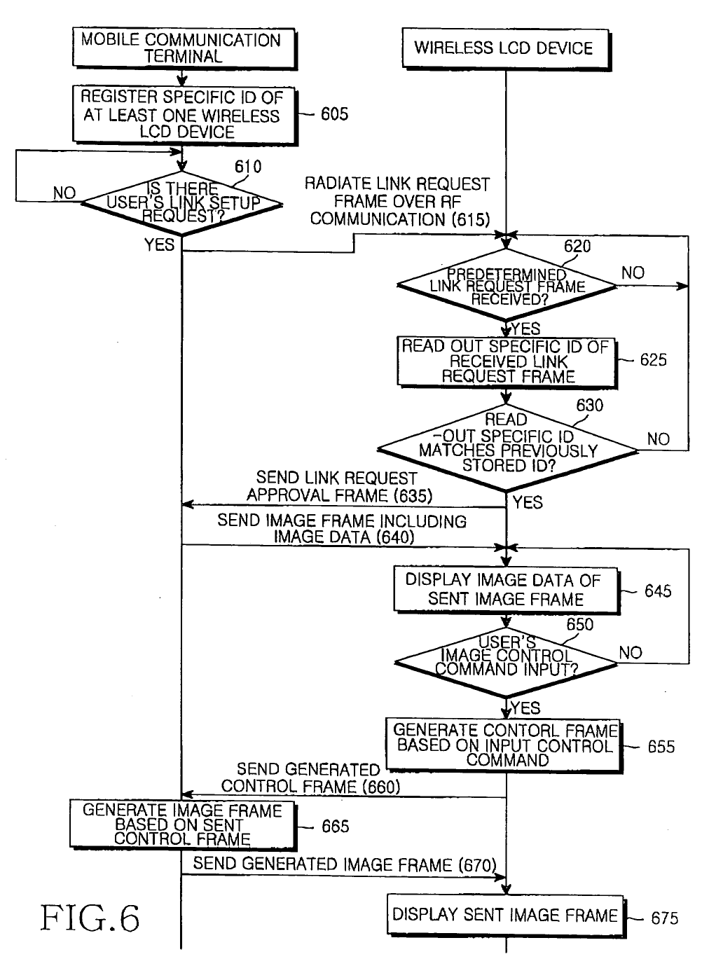

FIG. 6 is a flowchart illustrating a link setting process and a data exchanging process for bidirectional communication according to an embodiment of the present invention.

In order to display the images on the LCD device 300 to be connected thereto by wireless communication, the mobile communication terminal 400 registers a LCD ID which is a specific ID of the LCD device 300 to be connected thereto at step 605. Step 605 for registering the LCD ID may be performed by a manufacturer prior to a user receiving the device if both the mobile communication terminal and the corresponding wireless LCD device are manufactured together. Alternatively, the user may use step 605 for registering with the mobile communication terminal, for example, a specific ID (LCD ID) of an extra or another separate LCD device whenever necessary. A registration manual for using step 605, or for registering the specific ID of the LCD device may be provided to the user along with the mobile communication terminal.

After having completed the registration step 605, the related mobile communication terminal 400 can exchange necessary data with the wireless LCD device 300, the ID of which is now registered on the corresponding terminal unless the registration thereof is canceled or removed.

The mobile communication terminal 400 checks for a user link setup request, at step 610.

If there is the user's link setup request, the related mobile communication terminal 400 transmits a link request frame with a LCD ID inserted thereto at step 615.

When receiving the link request frame, at step 620, the LCD device 300 reads and identifies the ID with which the link request frame has been transmitted at step 625.

The LCD device 300 determines if the read ID matches a specific ID stored previously in the wireless LCD device 300, at step 630.

If the read ID matches the specific ID, the wireless LCD device 300 transmits a link request approval message to the mobile communication terminal 400 to set up the desired link, at step 635. Specifically, the wireless LCD device 300 reads the LCD ID of the radiated link request frame to determine whether it is a destination of the link request.

If a link request approval frame has been transmitted from the wireless LCD 300 and the desired link has been established, the mobile communication terminal 400 transmits an image frame having predetermined image data to the wireless LCD device 300, at step 640.

When receiving the predetermined image frame, the wireless LCD device 300 extracts the image data from the received image frame to display the extracted image data, at step 645.

The wireless LCD device 300 determines if the user's control commands are input for controlling the image data, at step 650. The image control commands comprises, for example, a repeat command, stop command, extend command and so on of the displayed images.

When receiving the image control commands, the wireless LCD device 300 generates the control frames based on the received commands, at step 655.

The wireless LCD device 300 transmits the generated control frames to the mobile communication terminal 400, at step 660.

When receiving the control frames from the wireless LCD device 300, the mobile communication terminal 400 generates the image frames based on the received control frames, at step 665, and transmits the generated image frames to the wireless LCD device 300, at step 670.

The wireless LCD device 300 receives and displays the generated image frames, at step 675.

Meanwhile, as mentioned above, the wireless link between the mobile communication terminal and the wireless LCD device is, in principle, one to one communication type (Point-to-Point). However, if it is necessary for one mobile communication terminal to transmit the same image to a plurality of wireless LCD devices, the wireless link between them may be one to N communication type (Point-to Multipoint).

In order to realize this one to N communication, in the mobile communication terminal of in accordance with an embodiment of the present invention, a link request frame can have a plurality of LCD IDs which correspond to the corresponding wireless LCD devices to be transmitted respectively, and whereby a plurality of wireless LCD devices can be set to be linked with one portable terminal to exchange the necessary data between them.

While the invention has been shown and described with reference to certain embodiments of the exemplary wireless LCD device, the principle of the present invention may be applied to a display device of a non-LCD type. That, is, it will be understood by those skilled in the art that various changes in form and details may be made therein without departing from the spirit and scope of the invention as defined by the appended claims.

As mentioned above, the embodiments of the present invention can provide the wireless display device and the method thereof in which the bi-directional communication can be performed between the mobile communication terminal and the wireless display device, whereby a variety of applications for controlling dynamic images can be realized.

Also, the embodiments of the present invention have an advantage in that the users' convenience can be improved significantly because one mobile terminal can communicate with a plurality of wireless display or LCD devices.

What is claimed is:

1. A wireless liquid crystal display (LCD) apparatus comprising:
a mobile communication terminal for establishing a link through which at least one wireless display device is linked to the mobile communication terminal, and transmitting image frames having image data to the linked wireless display device, wherein when receiving control frames for controlling the image frames from the wireless display device, the mobile communication terminal generates image frames based on the received control frames; and
a wireless display device for receiving the image frames from the mobile communication terminal and displaying image data of the received image frames, if the wireless display device is linked to the mobile communication terminal in response to a link setup request of the mobile communication terminal, wherein when receiving a user's control command for controlling the image data, the wireless display device generates the control frames based on the received control command and transmits the generated control frames to the mobile communication terminal.

2. The wireless LCD apparatus as claimed in claim 1, wherein the mobile communication terminal pre-registers at least one specific ID of the wireless display device, and if the user's link setup request is received, transmits a link request frame having one of the specific IDs.

3. The wireless LCD apparatus as claimed in claim 1, wherein the wireless display device comprises:
a key input section for receiving image control commands;
a power source for supplying power to the wireless display device;
a LCD radio frequency (RF) module for receiving the image frames comprising the image data from the mobile communication terminal and transmitting the control frames comprising the image control data to the mobile communication terminal over a bi-directional communication link;
a displaying section for displaying the image data extracted from the received image frames; and
a controller receiving an image control command through the key input section, generating the control frame based on the received image control command, and transmitting the generated control frame to the mobile communication terminal through the LCD RF module.

4. The wireless LCD apparatus as claimed in claim 3, wherein when receiving the link request frame from the mobile communication terminal, the controller performs a control for transmitting a link request approval frame to the mobile communication terminal and establishing the link.

5. The wireless LCD apparatus as claimed in claim 4, wherein when receiving the link request frame, the controller reads out the specific ID of the received link request frame, and if the read-out specific ID matches the previously-stored specific ID, the controller transmits the link request approval frame to the mobile communication terminal through the LCD RF module.

6. The wireless LCD apparatus as claimed in claim 3, wherein when the image frame, which has been generated in the mobile communication terminal based on the control frame, is received in the LCD RF module, the controller performs a control for extracting the image data from the image frame and displaying the extracted image data on the display section.

7. The wireless LCD apparatus as claimed in claim 3, wherein the power source comprises a charging module for charging power supplied to the wireless display device.

8. The wireless LCD apparatus as claimed in claim 3, wherein the LCD RF module comprises:
a LCD synchronizer for synchronizing the wireless display device with the mobile communication terminal for RF communication;
a LCD encoder for adding headers and transmitting protocols to the control data to generate the control frames;
a LCD sending end for transmitting the control frames generated in the LCD encoder; and
a LCD receiving end for receiving the image frames from the mobile communication terminal; and
a LCD decoder for extracting the image data from the received image frames to decode the extracted image data.

9. The wireless LCD apparatus as claimed in claim 8, wherein the apparatus further comprises:
a LCD sending buffer for storing temporally therein the control frames generated in the LCD encoder and
a LCD receiving buffer for storing temporally therein the image frames received through the LCD receiving end.

10. The wireless LCD apparatus as claimed in claim 1, wherein the image frame comprises header sectors for storing therein basic information for wireless RF communication with the mobile communication terminal, and data sectors for storing therein the image data to be transmitted to the mobile communication terminal.

11. The wireless LCD apparatus as claimed in claim 1, wherein the control frame comprises header sectors for storing therein basic information for wireless RF communication, and data sectors for storing therein the control data generated by the user's request.

12. The wireless LCD apparatus as claimed in claim 10, wherein the header sectors comprises a terminal ID comprising a specific ID of the mobile communication terminal, a LCD ID comprising a specific ID of the wireless display devices, and a communication protocol identifier for identifying the communication protocols.

13. The wireless LCD apparatus as claimed in claim 11, wherein the header sectors comprises a terminal ID comprising a specific ID of the mobile communication terminal, a LCD ID comprising a specific ID of the wireless display devices, and a communication protocol identifier for identifying the communication protocols.

14. A method for exchanging data in a mobile communication terminal between at least one a wireless display device apparatus and a mobile communication terminal, the method comprising the steps of:
registering each specific ID of said at least one wireless display device to the mobile communication terminal;
transmitting a link request frame comprising the specific ID over the wireless communication, if there is a user's link setup request;
transmitting image frames comprising image data to the wireless display device, if a link request approval frame has been transmitted from a predetermined wireless display device having its own specific ID and a link has been set up based on the link request approval frame; and
generating an image frame based on a control frame and transmitting the generated image frame to the wireless display device, if the control frame for controlling the image frame has been transmitted from the wireless display device.

15. The method as claimed in claim 14, wherein the image frame comprises header sectors for storing therein basic information for wireless RF communication, and data sectors for storing therein the image data to be transmitted to the mobile communication terminal.

16. The method as claimed in claim 14, wherein the control frame comprises header sectors for storing therein basic information for wireless RF communication, and data sectors for storing therein the control data generated by the user's request.

17. The method as claimed in claim 15, wherein the header sectors comprise a terminal ID comprising a specific ID of the mobile communication terminal, a LCD ID comprising a specific ID of the wireless display device, and a communication protocol identifier for identifying the communication protocols.

18. The method as claimed in claim 16, wherein the header sectors comprise a terminal ID comprising a specific ID of the mobile communication terminal, a LCD ID comprising a specific ID of the wireless display device, and a communication protocol identifier for identifying the communication protocols.

19. A method for exchanging data in the wireless display device which receives images from a predetermined mobile communication terminal and displays the received images thereon, the method comprising the steps of:
transmitting a frame for accepting a link request approval frame to the mobile communication terminal and establishing a link based on the link request approval frame, if a link request frame is received from the mobile communication terminal;
displaying image data included in a predetermined image frame, if the predetermined image frame is received from the mobile communication terminal to which the link has been established;
generating a control frame based on an image control command to transmit the generated control frame to the mobile communication terminal, if the image control command for controlling the image data is received; and
receiving, from the mobile communication terminal, the image frame which has been generated based on the control frame, and displaying an image data corresponding to the received image frame.

20. The method as claimed in claim 19, wherein the image frame comprises header sectors for storing therein basic information for wireless radio frequency (RF) communication with the mobile communication terminal, and data sectors for storing therein the image data to be transmitted to the mobile communication terminal.

21. The method as claimed in claim 19, wherein the control frame comprises header sectors for storing therein basic information for wireless radio frequency (RF) communication with the mobile communication terminal, and data sectors for storing therein the control data generated by the user's request.

22. The method as claimed in claim 20, wherein the header sectors comprise a terminal ID comprising a specific ID of the mobile communication terminal, a liquid crystal display (LCD) ID comprising a specific ID of the wireless display device, and a communication protocol identifier for identifying the communication protocols.

23. The method as claimed in claim 21, wherein the header sectors comprise a terminal ID comprising a specific ID of the mobile communication terminal, a liquid crystal display (LCD) ID comprising a specific ID of the wireless display device, and a communication protocol identifier for identifying the communication protocols.

24. The method as claimed in claim 19, wherein the step of establishing the link based on the link request approval frame comprises the steps of:
reading out a specific ID of the link request frame, if the link request frame is received;
determining if the read-out specific ID matches a previously-stored specific ID; and
transmitting the link request approval frame to the mobile communication terminal, and establishing the link, if the read-out specific ID matches the previously-stored specific ID.
